(19) United States
(12) Patent Application Publication
(10) Pub. No.: US 2007/0098561 A1
(43) Pub. Date: May 3, 2007

(54) Rotor blade for wind power plants

(75) Inventor: Hermann Rochholz, Norderstedt (DE)

Correspondence Address: VIDAS, ARRETT & STEINKRAUS, P.A., 6109 BLUE CIRCLE DRIVE, SUITE 2000, MINNETONKA, MN, 55343-9185, US

(73) Assignee: Nordex Energy GmbH, Norderstedt (DE)

(21) Appl. No.: 11/585,594

(22) Filed: Oct. 24, 2006

(30) Foreign Application Priority Data
Oct. 29, 2005 (DE) 10 2005 051 931.8

(51) Int. Cl. B64C 27/46

(52) U.S. Cl. 416/223 R

(57) ABSTRACT

A rotor blade for a wind power plant, comprising an upper shell and a lower shell which are joined to each other and have a trailing edge each, and which has a profile extending in the direction of flow and, at its rear end, exhibiting a profile trailing edge of a thickness, wherein the trailing edges of the upper and lower shells are spaced apart in at least one area of the rotor blade such that the thickness of the profile trailing edge is defined by one of the shells.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

This invention relates to a rotor blade for wind power plants by which characteristics which are particularly beneficial, specifically a reduced noise development, are achieved in a simple way.

Conventionally, rotor blades for wind power plants are constructed from fibre-reinforced plastic materials. During this procedure, an upper shell and a lower shell initially are manufactured from a fibre-reinforced plastic material and, subsequently, are adhered to each other at least in the area of the leading and trailing edges. This way of construction allows to produce light-weight sturdy rotor blades of a configuration which is freely selectable to a large extent.

However, a problem is posed by the noise development inherent to the operation of wind power plants. Such operational noise arises, to a significant degree, from wind noise which is caused around the rotor blades's trailing edge where the air volumes flowing along the suction side and pressure side of the rotor blade impact onto each other, causing pressure gradients and turbulences will occur. To mitigate this problem, DE 195 80 147 T1, the entire contents of which is incorporated herein by reference, proposes to incorporate a flexible material, e.g. an elastromer strip, into the area of the profile trailing edge. The elastromer strip is of a rhombic cross-section here one end of which fits into a gap which is formed between the two shell halves provided with a specific profile design. Similarly, it is also possible to incorporate strips of a woven oder knit fabric. In addition, DE 197 43 694 A1 indicates a specific profile design of the rotor blade's trailing edge which is also thought to reduce the noise level. This profile design is formed in such a way that the degree of rotor blade taper towards the rotor blade's trailing edge increases stepwise, but without forming a stair-like step. In contrast, from DE 196 14 420 C2, the entire contents of which is incorporated herein by reference,it has been known to provide the upper and lower sides of the rotor blade's trailing edge with a stair-like gradation. What all technologies referred to have in common is that they require comparatively large efforts in their manufacturing methods.

It is the object of the invention to provide a rotor blade which generates noise to a low extent and can be produced at a low manufacturing expenditure in the area of the trailing edge.

### BRIEF SUMMARY OF THE INVENTION

According to the invention, the object is achieved by a rotor blade for a wind power plant, comprising an upper shell and a lower shell which are joined to each other and have a trailing edge each, and which has a profile extending in the direction of flow and, at its rear end, exhibiting a profile trailing edge of a thickness, wherein the trailing edges of the upper and lower shells are spaced apart in at least one area of the rotor blade such that the thickness of the profile trailing edge is defined by one of the shells.

The object is also achieved by a rotor blade having a trailing edge the upper shell and the lower shell of which are joined to each other and which have a trailing edge each wherein one of the trailing edges of the shells extends closer to the trailing edge of the rotor blade than does the rear edge of the other shell, at least in one area of the rotor blade. Here, the trailing edge of the rotor blade signifies that part of the entire rotor blade which is located farthest rearwards in relation to the direction of flow. Depending on the aspect, the trailing edge of the rotor blade may coincide with one of the trailing edges of the upper or lower shell or may be formed by a further component which approximately is strip-shaped.

According to the invention, the rotor blade is composed of an upper shell and a lower shell which are joined to each other and are of a depth each between the leading edge and trailing edge, with one of the shells being of a depth larger than that of the other shell such that one of the shells overhangs the other shell, at least in one area of the rotor blade.

This arrangement of the inventive shells allows to avoid that the upper and lower shells are located on top of each other in the area of the trailing edge and, while lying on top of each other, will inevitably cause a thickness of the trailing edge which at least corresponds to the sum of material thicknesses of the upper and lower shells and the adhesive bond between them. The trailing edge of the rotor blade itself may be formed directly by the rear edge of one of the two shell halves or more elements may be employed to join the two shell halves in the area of the trailing edge here, thus defining the rear edge proper of the rotor blade. Additional elements of this type may present a thickness which is small as compared to the thickness of two superimposed, flushly finishing shell halves so that the inventive arrangement of the shell halves altogether allows to achieve a smaller thickness of the trailing edge despite the additional element.

The invention relies on the finding that a rotor blade's trailing edge which is as thin as possible is important to reduce the noise caused by wind. A value of 1 to 10 per mil, preferably 1 to 5 per mil of profile depth, can be considered a recommended value of the maximum thickness of a rotor blade's profile trailing edge. For example, if the profile depth is one metre this is equal to a maximum thickness of abt. 2 mm for a relative profile thickness of 2 per mil. For a conventional way of cnstruction where the upper shell and the lower shell are of a thickness of one millimeter each in the area of the trailing edge, for example, and are adhered onto each other in the area of the trailing edge, it is difficult to achieve this value because even more layers such as adhesive, varnish or gel coat layers will thicken the profile trailing edge.

According to an aspect, the trailing edge of the rotor blade coincides with the trailing edge of the upper shell. This means that the trailing edge of the upper shell forms the trailing edge of the rotor blade. This helps achieve that the thickness of the rotor blade's trailing edge is governed by the thickness of the upper shell's trailing edge. A provision is made to adhere the two shell halves to each other in the area of the trailing edge. This leads to a particularly sturdy arrangement since torsional stability will be increased specifically in rotor blade profiles having long, thin trailing edges as are employed in advanced rotor blade profiles. Another advantage is that the use of material can be diminished. In addition, it ensures that the trailing edge is of a uniform thickness which only depends on the thickness of the upper shell. The manufacture of the rotor blade is possible without involving extra efforts in manufacture.

According to another aspect, a further component which forms the trailing edge of the rotor blade is used along the trailing edge of the rotor blade. Hence, the trailing edge of the extra component coincides with the trailing edge of the rotor blade. The thickness of the rotor blade's trailing edge is solely dictated by the thickness of the trailing edge of the extra component in this case. The inventive arrangement of the trailing edges of the upper and lower shells makes it possible to keep the thickness of the extra component, which is rhombic or strip-shaped, smaller than the thickness of the two trailing edges of the upper and lower shells that are located on top of each other and finish flushly with each other. Hence, it is unnecessary to give the trailing edges of the two shell halves a particular profile which terminates flat, for example, to enable the incorporation of a particularly thin, strip-shaped element.

According to another aspect, the step which forms at the trailing edge of the shell halve which is more distant from the rotor blade's trailing edge is scraped down in order to achieve a flow-promoting profile in the area of the rotor blade's trailing edge.

According to another aspect, the trailing edge of that shell which does not define the rotor blade's trailing edge is beveled such as to bear flat on the inside of the other shell. This helps avoid the formation of a stair in the area of the trailing edge concerned. An advantageous adhesive bond can also be attained, depending on the shape of the profile.

### BRIEF DESCRIPTION OF SEVERAL VIEWS OF THE DRAWINGS

The invention will be described in more detail below by way of an embodiment. In the drawings:

FIG. 1 shows a rotor blade in cross-section,

FIG. 2 shows a trailing edge of an inventive rotor blade in cross-section,

FIG. 3 shows a trailing edge of another embodiment of an inventive rotor blade in cross-section,

FIG. 4 shows a trailing edge of a rotor blade matuching the state of the art in cross-section.

The same reference numbers are used for all Figures.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

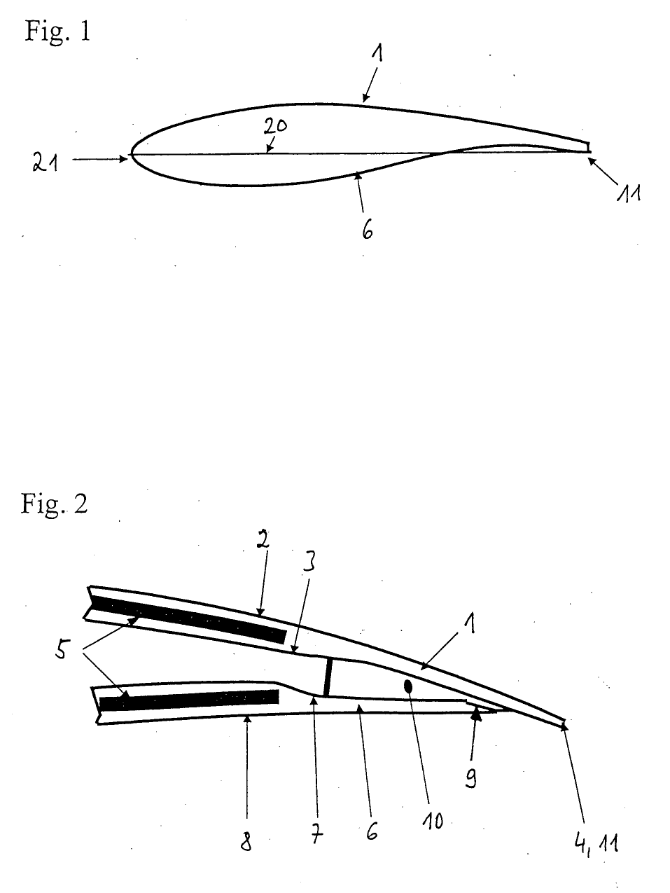

The rotor blade illustrated in cross-section in FIG. 1 is composed of an upper shell I and a lower shell 6. The profile is completed rearwards by the profile trailing edge 11. The leading edge of the profile is defined by the profile nose 21. A profile chord 20 is also shown in the drawing.

FIG. 4 depicts the state of the art, showing a rotor blade's trailing edge in cross-section. Upper shell 1 has an outside 2, an inside 3, and a trailing edge 4 and is partially filled with a spacer material 5, e.g. balsa wood or a foamed substance. The same applies to the lower shell 6 which has an inside 7, an outside 8, and a trailing edge 9. The area 10 between the two shell halves 1, 6 is filled with an adhesive to join the upper and lower shells 1, 6. The trailing edges 4, 9 both coincide with the profile trailing edge 11. The thickness of the profile trailing edge 11 is defined by the two trailing edges 4, 9. Therefore, it is at least twice the size of the material thickness of the shells 1, 6 in the area of the trailing edge plus the adhesive which needs to be of a certain thickness.

Referring to the trailing edge shown in FIG. 1 for a rotor blade of an inventive design, the trailing edges 4, 9 of the upper and lower shells are not adhered to each other flushly, but in a way ensuring that the trailing edge 9 of the lower edge 6 isat a distance from the profile trailing edge 11. The trailing edges 4, 9 are spaced apart in such a manner that the thickness of the profile trailing edge 11 is defined by the trailing edge 4 of the upper shell 1. This helps achieve an evenly small thickness of the rotor blade's trailing edge.

In the rotor blade illustrated, the top layer of the shell elements consists of glass fibre reinforced polyester or epoxide resin. The shells are adhered to each other using polyester, epoxide or polyurethane resins.

In the manufacturing technology, an optimum joint between the shells is achieved by applying the adhesive resin to one of the shells, preferably the lower shell while still in the manufacturing mould. The shell not provided with the adhesive resin also is still in its manufacturing mould. The upper and lower shells are then placed on top of each other and are pressed onto each other to achieve an adhesive thickness which is as thin as possible, but is sufficient for a solid joint at the trailing edges.

When the shells are pressed onto each other a support is provided, for example, by hydraulic cylinders which apply a large pressure.

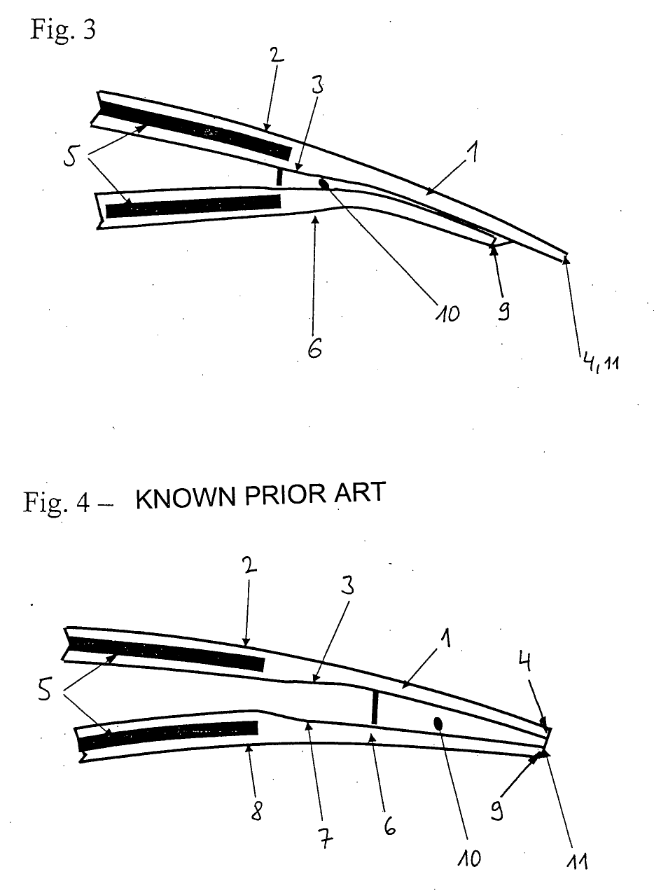

The trailing edge of a further inventive rotor blade is illustrated in FIG. 3. This rotor blade has a profile which is characterited by a particularly pronounced bulge in the rear region. This frequently is the case for advanced rotor blade profiles, e.g. the so-called Risø profiles.

The upper shell I and the lower shell 6 extend nearly in parallel over a major area in the area of the trailing edge. This allows a reduction in the adhesive volume necessary in the area 10.

Likewise, the scaped-down step is shown in the area of the trailing edge 9 of the lower shell 6. This trailing edge is not of a beveled design, in contrast to FIG. 2, which allows to save efforts in manufacture.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. A rotor blade for a wind power plant, comprising an upper shell (1) and a lower shell (6) which are joined to each other and have a trailing edge (4, 9) each, and which has a profile extending in the direction of flow and, at its rear end, exhibiting a profile trailing edge (11) of a thickness, characterized in that the trailing edges (4, 9) of the upper and lower shells (1, 6) are spaced apart in at least one area of the rotor blade such that the thickness of the profile trailing edge (1) is defined by one of the shells.

2. The rotor blade for a wind power plant, comprising an upper shell (1) and a lower shell (6) which are joined to each other and have a trailing edge (4, 9) each, and which has a profile extending in the direction of flow and, at its rear end, exhibiting a profile trailing edge (11) of a thickness, characterized in that another, strip-shaped component is provided which defines the thickness of the profile trailing edge (11) wherein the trailing edges (4, 9) of the upper and lower shells (1, 6) are spaced apart such as to be at a different distance from the profile trailing edge (11).

3. The rotor blade according to claim 1, characterized in that the thickness of the profile trailing edge (11) is defined by the upper shell (1).

4. The rotor blade according to claim 2, characterized in that the trailing edge (9) of the lower shell (6) is at a larger distance from the profile trailing edge (11) than is the trailing edge (4) of the upper shell.

5. The rotor blade according to claim 1, characterized in that a step is scraped down in the area of the trailing edge of that shell which does not define the thickness of the profile trailing edge.

6. The rotor blade according to claim 2, characterized in that the step which forms in the area of the trailing edge (4) of the upper shell (1) and/or trailing edge (9) of the lower shell (6) is scraped down.

7. The rotor blade according to claim 1, characterized in that the trailing edge of that shell which does not define the profile trailing edge (11) is beveled such as to bear flat on the inside of the other shell.
